(19) United States
(12) Patent Application Publication
(10) Pub. No.: US 2026/0203068 A1
(43) Pub. Date: Jul. 16, 2026

(54) HAZARD-CHECKING IN TASK DELEGATION

(71) Applicant: Arm Limited, Cambridge (GB)

(72) Inventors: Mbou Eyole, Cambridge (GB); Richard Roy Grisenthwaite, Cambridge (GB); Robert Gwilym Dimond, Cambridge (GB)

(73) Assignee: Arm Limited, Cambridge (GB)

(21) Appl. No.: 19/490,142

(22) PCT Filed: Feb. 8, 2024
(86) PCT No.: PCT/GB2024/050344

§ 371 Date: Dec. 4, 2025

(30) Foreign Application Priority Data
Jun. 5, 2023 (GB) 2308372.8

(51) Int. Cl. G06F 9/38; G06F 12/02

(52) U.S. Cl. CPC G06F 9/3867; G06F 12/0223

(57) ABSTRACT

An apparatus for data processing comprises a data processing pipeline to perform data processing operations, and extension processing circuitry to perform a delegated task asynchronously to the data processing pipeline in response to the decoding circuitry decoding an extension start instruction. The apparatus also comprises hazard detection circuitry to detect data hazards associated with processing operations performed by the data processing pipeline. When the data processing pipeline is in an extension hazard checking state, the presence of a hazard condition can be determined in dependence on whether a given memory access, to be performed in response a given memory access instruction following the extension start instruction in program order, is for accessing an address which falls within a group of addresses anticipated to be accessed by the extension processing circuitry during performance of the delegated task.

The present technique relates to the field of data processing.

An apparatus may comprise a data processing pipeline configured to perform data processing operations in dependence on a received sequence of instructions. It may be desirable to improve performance whilst performing the data processing operations, without impacting the correctness of the data processing operations performed.

At least some examples provide an apparatus for data processing, comprising
a data processing pipeline comprising decoder circuitry responsive to receipt of instructions of a sequence of instructions to generate control signals to control the data processing pipeline to perform data processing operations;
extension processing circuitry associated with the data processing pipeline and configured to perform a delegated task asynchronously with respect to the data processing operations performed by the data processing pipeline, in response to the decoding circuitry decoding an extension start instruction; and
hazard detection circuitry to detect data hazards associated with processing operations performed by the data processing pipeline when the data processing pipeline is in an extension hazard checking state in respect of the delegated task; wherein
when the data processing pipeline is in the extension hazard checking state in respect of the delegated task, the hazard detection circuitry is configured to determine the presence of a hazard condition in dependence on whether a given memory access, to be performed in response to execution by the data processing pipeline of a given memory access instruction following the extension start instruction in program order, is for accessing an address which falls within a group of addresses indicated by grouped address indicating data; and
the hazard detection circuitry is responsive to the presence of the hazard condition to perform a hazard resolution action.

At least some examples herein provide a non-transitory computer-readable medium to store computer-readable code for fabrication of the apparatus mentioned above.

At least some examples provide a method for data processing, comprising
performing data processing operations in a data processing pipeline in dependence on instructions of a sequence of instructions decoded by a decoder;
performing a delegated task in extension processing circuitry associated with the data processing pipeline asynchronously with respect to the data processing operations performed by the data processing pipeline, in response to the decoding circuitry decoding an extension start instruction; and
detecting, with hazard detection circuitry, data hazards associated with processing operations performed by the data processing pipeline when the data processing pipeline is in an extension hazard checking state in respect of the delegated task;
when the data processing pipeline is in the extension hazard checking state in respect of the delegated task, employing the hazard detection circuitry to determine the presence of a hazard condition in dependence on whether a given memory access, to be performed in response to execution by the data processing pipeline of a given memory access instruction following the extension start instruction in program order, is for accessing an address which falls within a group of addresses indicated by grouped address indicating data; and
responsive to the presence of the hazard condition, performing a hazard resolution action.

At least some examples provide a computer program for controlling a host data processing apparatus to provide an instruction execution environment, the computer program comprising:
data processing pipeline program logic comprising decoder program logic responsive to receipt of instructions of a sequence of instructions to generate control signals to control the data processing pipeline program logic to perform data processing operations;
extension processing program logic associated with the data processing pipeline program logic and configured to perform a delegated task asynchronously with respect to the data processing operations performed by the data processing pipeline program logic, in response to the decoding program logic decoding an extension start instruction; and
hazard detection program logic to detect data hazards associated with processing operations performed by the data processing pipeline program logic when the data processing pipeline program logic is in an extension hazard checking state in respect of the delegated task; wherein
when the data processing pipeline program logic is in the extension hazard checking state in respect of the delegated task, the hazard detection program logic is configured to determine the presence of a hazard condition in dependence on whether a given memory access, to be performed in response to execution by the data processing pipeline program logic of a given memory access instruction following the extension start instruction in program order, is for accessing an address which falls within a group of addresses indicated by grouped address indicating data; and
the hazard detection program logic is responsive to the presence of the hazard condition to perform a hazard resolution action.

The computer program may be stored on a computer-readable medium. The medium may be non-transitory.

Further aspects, features and advantages of the present technique will be apparent from the following description of examples, which is to be read in conjunction with the accompanying drawings, in which:

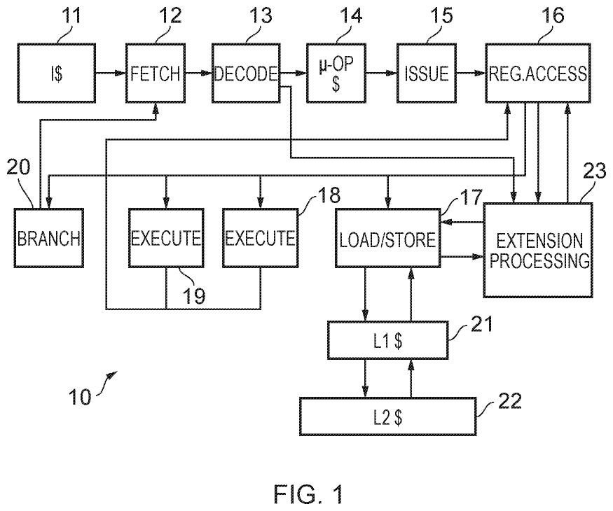

FIG. 1 schematically illustrates a data processing apparatus which may embody various examples of the present techniques;

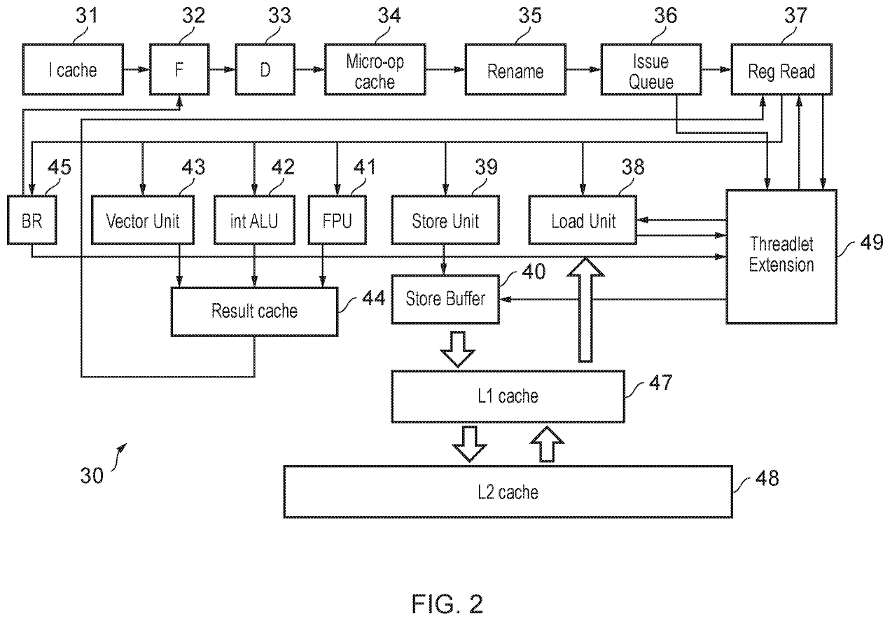

FIG. 2 schematically illustrates a data processing apparatus which may embody various examples of the present techniques;

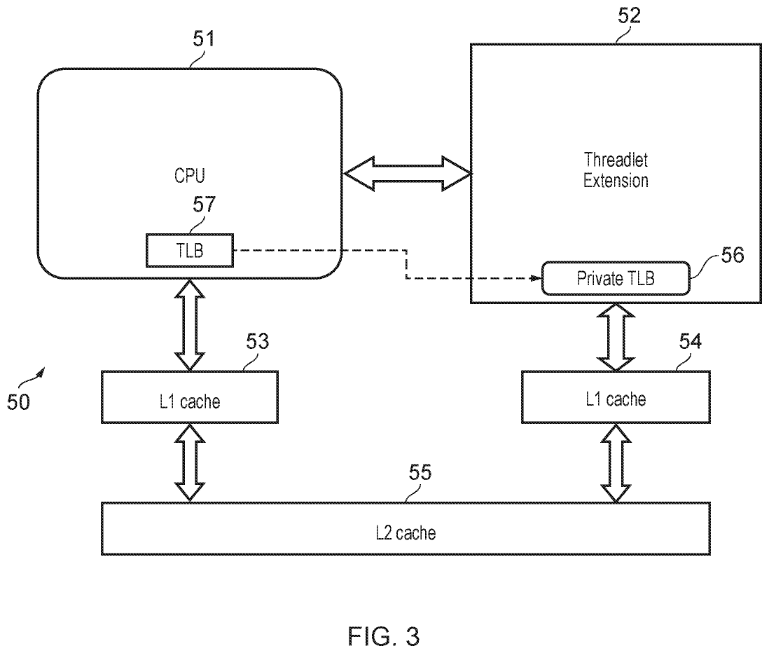

FIG. 3 schematically illustrates a data processing apparatus which may embody various examples of the present techniques;

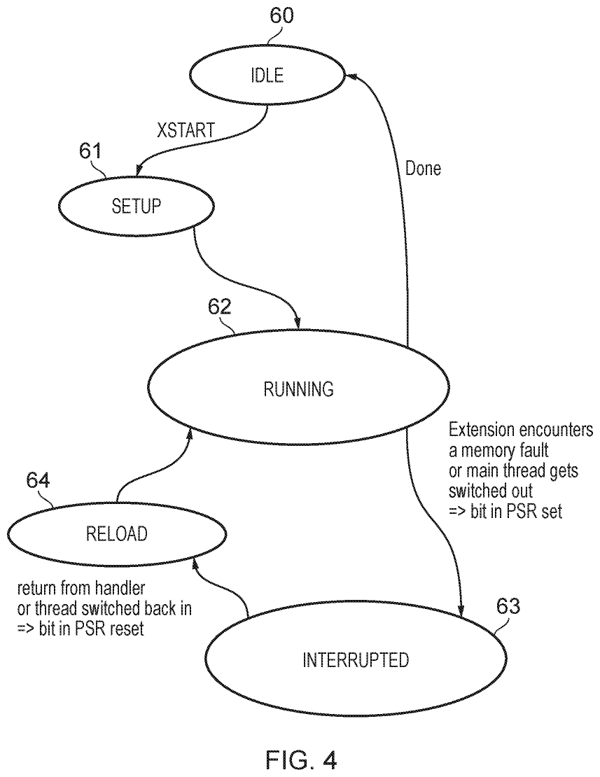

FIG. 4 is a state diagram illustrating an example set of states between which extension processing circuitry of the present techniques may transition;

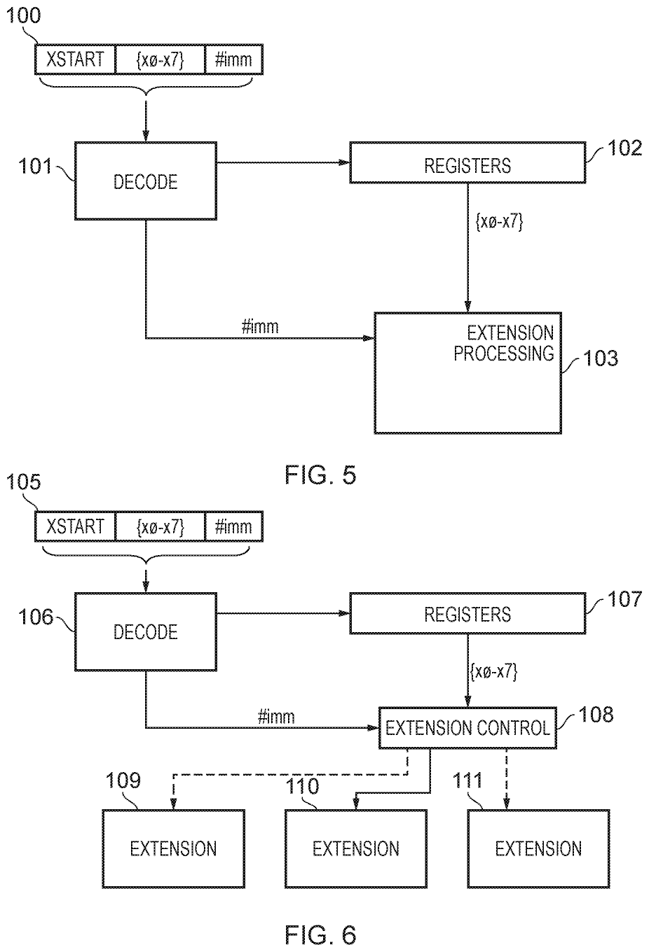

FIG. 5 schematically illustrates an extension start instruction delegating a task to extension processing circuitry in accordance with some examples;

FIG. 6 schematically illustrates an extension start instruction delegating a task to one of several instances of extension processing circuitry in accordance with some examples;

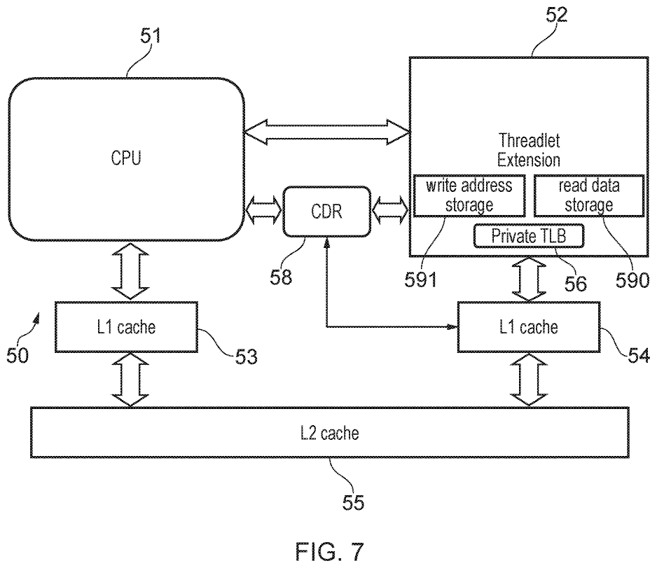

FIG. 7 schematically illustrates a data processing apparatus which may embody various examples of the present techniques;

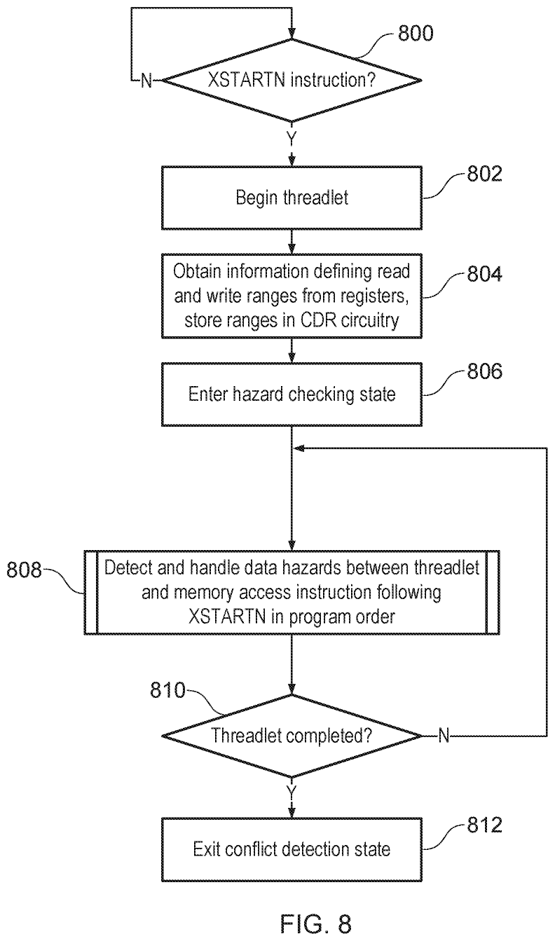

FIG. 8 is a flow diagram showing a sequence of steps that are taken in response to decoding an extension start instruction according to some examples;

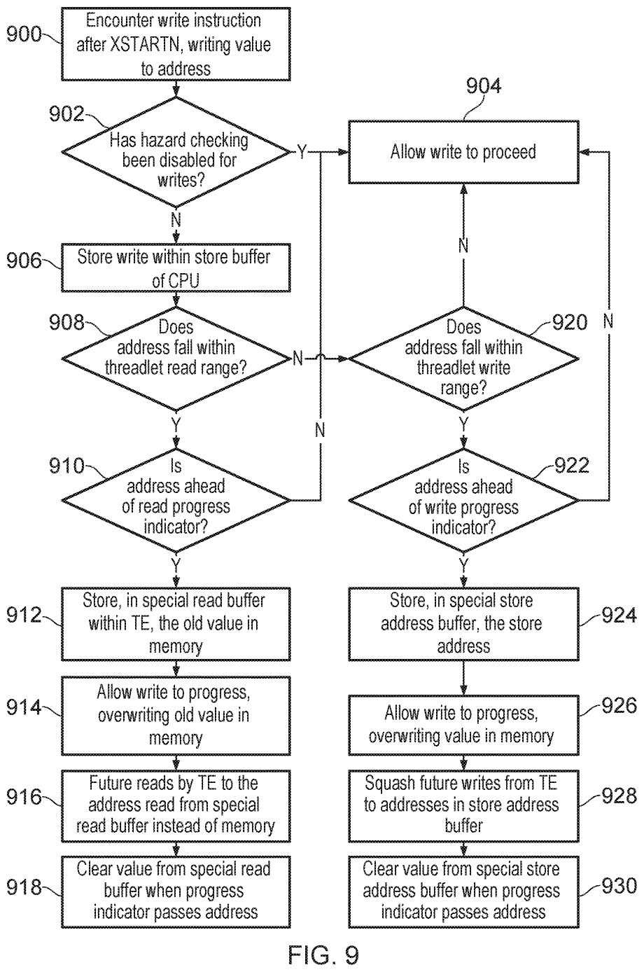

FIG. 9 is a flow diagram showing a sequence of steps that are taken in response to decoding a write instruction according to some examples;

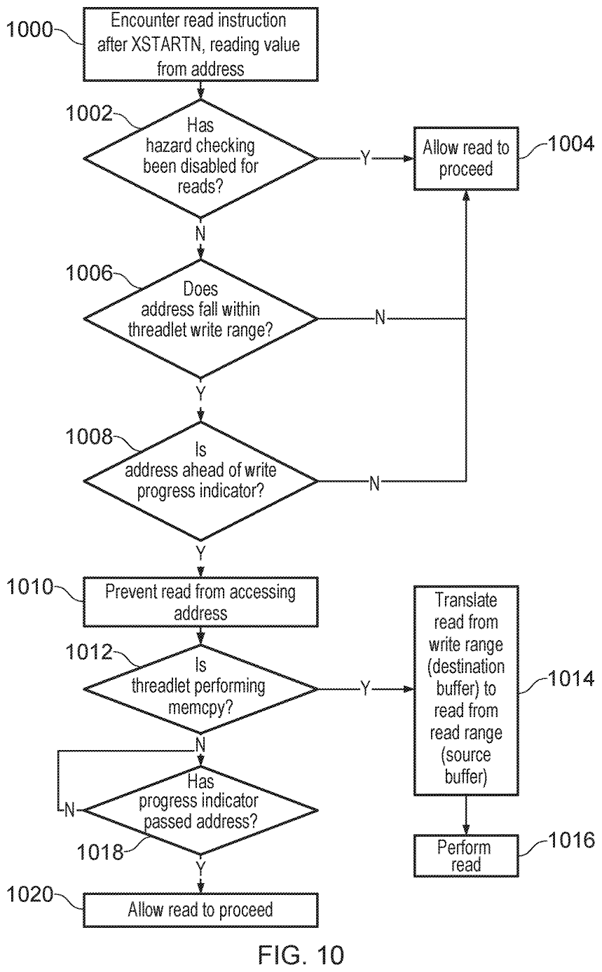

FIG. 10 is a flow diagram showing a sequence of steps that are taken in response to decoding a read instruction according to some examples;

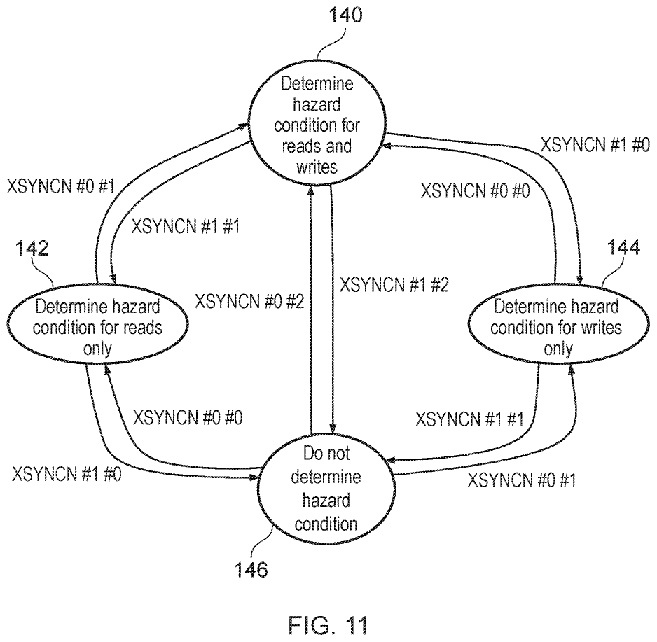

FIG. 11 is a state diagram illustrating an example set of states between which hazard detection circuitry of the present techniques may transition;

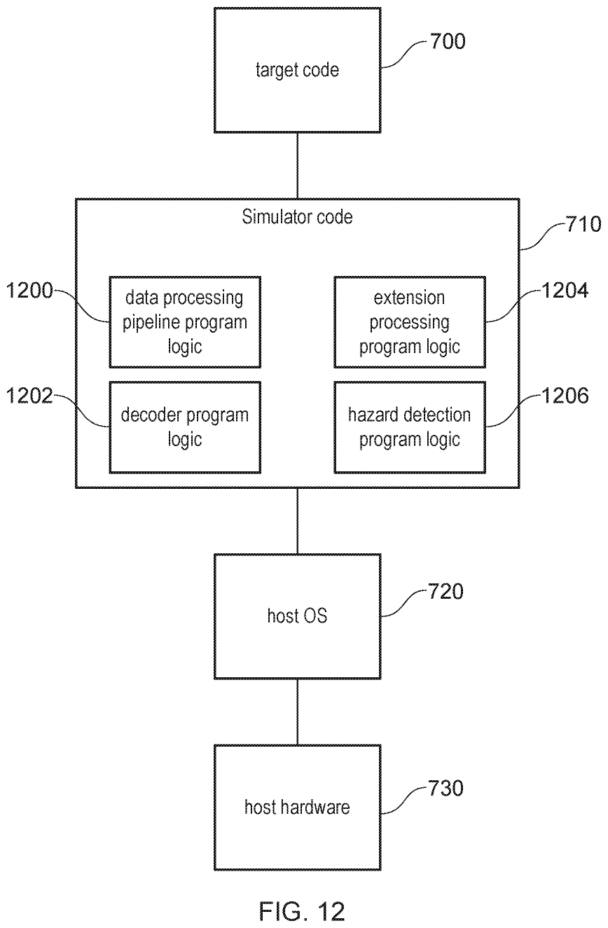

FIG. 12 schematically illustrates a simulator implementation that may be used.

An apparatus comprising a data processing pipeline can be required to perform a variety of data processing operations as defined by a sequence of instructions provided to it. In order efficiently to perform those data processing operations the data processing pipeline may be configured with a variety of functional units, each with a given specialised type of data processing ability, such as arithmetic logic units (ALUs), floating point (FP) units, load/store units, and so on. Yet even with such specialised functional units being provided as part of the data processing pipeline, the inventors of the present techniques have established that in some types of data processing, that is, in certain programs (i.e., sequences of instructions) there can be particular functions which are frequently executed and which require an amount of processing such that the provision of custom hardware dedicated to supporting these functions is worthwhile, since it could significantly impact the overall performance of the apparatus. In identifying such functions, two key properties were deemed to be relevant: a function's ubiquity (i.e., it can also be found in the many other use-cases) and a function's impact (i.e., the proportion of time spent executing such a function is a significant percentage of the overall runtime, such that improvements in that function's execution made a significant difference to the overall use-case). Such impactful, ubiquitous functions have been found to include tasks or functions such as memcpy, memset, compression, encryption, and string processing, although the present techniques are not limited to these particular examples. The present techniques provide extension processing circuitry that is associated with the data processing pipeline and is configured to perform such a function (a delegated task) in response to a delegation signal received from the data processing pipeline. Such extension processing circuitry may also be referred to as a threadlet extension (TE) herein. The extension processing circuitry, although closely associated (tightly coupled) with the data processing pipeline, is configured to perform the delegated task asynchronously to the data processing operations performed by data processing pipeline. The data processing pipeline may also be referred to as the CPU herein. Threadlets are functions or collections of operations that can be executed asynchronously relative to other CPU activity once launched. The asynchronous operation of the extension processing circuitry with respect to the data processing pipeline is possible because unlike some prior art techniques, the extension processing circuitry receives a directive or command from the thread currently executing on the CPU and performs the required operations independently, that is without requiring a stream of instructions from the CPU that directly control or influence its internal operation. The CPU is therefore free to continue executing other code and potentially reduce overall runtime by overlapping the execution of the instruction stream after the directive or command is sent to the extension processing circuitry with the operation of the extension processing circuitry.

The data processing pipeline may execute an extension start instruction causing the extension processing circuitry to begin performing the delegated task, and then proceed with processing instructions subsequent in the program order whilst the delegated task is being performed by the extension processing circuitry. However, this can give rise to the possibility of data hazards. During performance of the delegated task, the extension processing circuitry may perform memory accesses such as reads and writes to addresses within an address space shared with the data processing pipeline. For example, the extension processing circuitry and the data processing pipeline may share access to a main memory and one or more levels of shared cache. There may be a data dependency between memory accesses performed by the extension processing circuitry and memory accesses performed by the data processing pipeline.

Accesses to a particular location in memory may be expected to be performed in an order depending on the order of instructions which cause those accesses to be carried out (the program order). If this ordering is not respected, then data hazards can arise (including read-after-write, write-after-read, and write-after-write hazards) which can lead to incorrect results being calculated. In particular, memory accesses performed as part of the delegated task may be associated with the same point in the program order as the extension start instruction. Memory accesses caused by instructions following the extension start instruction in the program order may architecturally be expected to be carried out after any memory access of the delegated task. However, since the extension processing circuitry may operate asynchronously with respect to the data processing pipeline, the data processing pipeline may not be aware of which memory accesses have been performed as part of the delegated task by the extension processing circuitry, and therefore it could be difficult to identify potential data hazards.

If the data processing pipeline were to perform memory accesses in response to the instructions following the extension start instruction in the program order without regard to the extension processing circuitry, there would be a risk that those memory accesses could be performed before the extension processing circuitry has reached part of the delegated task involving a memory access to the same location, and therefore there is a risk that a memory access to be performed during the delegated task (earlier in the program order) is in fact carried out later than the memory access performed by the data processing pipeline in response to an instruction later in the program order.

One approach to avoiding a data hazard between the delegated task and data processing operations performed in response to subsequent instructions is to write the program in such a way that avoids potential hazards. For example, the program may be written to cause a subsequent memory access which has a data dependency on the delegated task to be performed only in response to some confirmation that the delegated task has reached a certain point where the data hazard is less likely to occur, such as the end of the delegated task. For example, an extension synchronisation instruction may be defined which determines whether the delegated task has reached a certain point, and the program reaching subsequent memory access instructions having a data dependency on the delegated task may be dependent on (e.g., located on a branch which is only reached in response to) the synchronisation instruction returning a value indicating that the delegated task has reached the certain point.

However, writing the program to avoid hazards between a delegated task and subsequent instructions places a potentially high burden on the programmer. In particular, it may be difficult to determine the presence of data dependencies between the delegated task and subsequent instructions, at least part of which may be due to difficulty determining the extent of producer-consumer relationships in code. A programmer may miss a data dependency, leading to a data hazard, or could be overly cautious and unnecessarily prevent certain memory accesses taking place, harming performance. In any case, the difficulty may discourage the use of the extension processing circuitry altogether, which would be undesirable from a performance perspective.

An alternative approach to preventing incorrect processing due to data hazards between the delegated task and data processing operations performed in response to subsequent instructions, placing less burden on the programmer, is to allow the execution of code in which reaching memory access instructions following the extension start instruction in program order is not dependent on prior knowledge that data hazards will not arise (e.g., due to synchronisation between the CPU and TE), and instead a tracking mechanism could be provided to seek to keep track of accesses made by both the CPU and TE, and to then identify and handle data hazards if and when they do arise.

Such an approach to identifying data hazards may be to generate read sets and write sets by tracking reads and writes made by the extension processing circuitry during performance of the delegated task, tracking reads and writes made by the processing pipeline whilst the delegated task is being performed, and identifying hazards based on comparisons between the sets of tracked memory accesses. However, such an approach requires the tracking of potentially large numbers of memory accesses, with memory accesses potentially being tracked until completion of the delegated task. As the size of the delegated task, and typically the number of memory accesses involved with performing the delegated task, increases, so too does the overhead associated with maintaining and using sets of tracked memory accesses for hazard checking. In addition to the potentially greater hardware outlay for storing the sets of tracked memory accesses, in cases where a context switch might be encountered, such as when the program is interrupted, it is undesirable to have large amounts of information pertaining to tracked memory addresses because this information would have to be saved and restored with the rest of the current context. This could have an adverse impact on the context size and reduce the speed of context switches. The inventors have therefore recognised that approaches based on tracking reads and writes do not scale well for large delegated tasks.

However, the inventors have made the observation that certain delegated tasks may have memory access characteristics which can be used to provide a scheme for identifying potential data hazards with a lower overhead than tracking read and write sets. In particular, tasks which may benefit from being delegated to the extension processing circuitry may include tasks which operate on data stored in regions of memory designated as a source buffer, and store results of the operations to regions of memory designated as a destination buffer, with the location of the source and destination buffers (which are not necessarily contiguous regions of memory) being known in advance. Examples of such tasks include memcpy involving the movement of data from a first region of memory (the source buffer) to a second region of memory (the destination buffer), encryption or compression of data stored in a first region of memory with the encrypted or compressed data being stored in the second region of memory, certain matrix processing operations, and so on. More generally, there are processing tasks which may be offloaded to the asynchronous extension processing circuitry, where it is known in advance that there are groups of addresses anticipated to be accessed by the extension processing circuitry during performance of the delegated task.

When delegating a task, where it is anticipated that certain groups of addresses will be accessed, to the extension processing circuitry, knowledge of the groups of addresses to and from which memory accesses are anticipated to be made can be used by hazard detection circuitry to identify data hazards. Grouped address indicating data may be made available to hazard detection circuitry, where the grouped address indicating data may indicate one or more groups of addresses anticipated to be accessed by the extension processing circuitry during performance of the delegated task. The hazard detection circuitry can make a determination of whether a data hazard may be present based on whether a memory access to be performed in response to execution by the data processing pipeline of an instruction following the extension start instruction in program order is for accessing a location in memory that falls within a group of addresses indicated by grouped address indicating data. Certain memory accesses may be compared against certain groups of types accesses anticipated to be performed by the extension processing circuitry, for example reads subsequent in the program order may only be compared against writes (and not reads) anticipated to be performed by the extension processing circuitry, as identified by grouped address indicating data indicative of addresses that will be used for such write accesses, although some memory accesses may be compared against all types of accesses anticipated to be performed by the extension processing circuitry, for example addresses of subsequent writes may be compared against one or more identified groups of addresses for both reads and writes anticipated to be performed by the delegated task (to identify both WAR and WAW hazards).

Hence, because it can be known when a task is delegated by the processing pipeline which groups of memory addresses the delegated task is anticipated to access, hazard checking for data processing operations performed by the processing pipeline can be performed with reference to those groups without keeping track of individual reads and writes. This can result in a significant reduction in the state which is required to be maintained during performance of a delegated task, whilst allowing support for an implementation that does not rely on the programmer writing code to avoid data hazards.

If a data hazard is detected, this can be handled in several ways which may depend on the type of memory accesses involved, but in general an action will be taken to resolve the potential data hazard and thereby prevent incorrect results being calculated as a result of a memory access instruction later in the program order being performed in advance of a memory access instruction earlier in the program order. In a basic example, where a potential data hazard is identified, the memory access of the instruction following the extension start instruction may be delayed until the delegated task has been completed. Further examples will be discussed below.

When the data processing pipeline is in the extension hazard checking state in respect of a particular delegated task, the hazard detection circuitry can be considered to be in a hazard checking state in respect of the particular delegated task in which it can determine whether there is a hazard condition present for that delegated task. Whilst the hazard detection circuitry could remain in the hazard checking state, it may also be possible for the hazard detection circuitry to exit the hazard checking state under certain conditions. For example, there may be regions of code where a programmer is not concerned about the possibility of data hazards, and does not require use of the hazard detection circuitry and in these circumstances the hazard checking state may be exited to reduce overhead, such as power and storage use, associated with the hazard detection circuitry. The extension processing circuitry may support processing of more than one delegated task at once, and the hazard detection circuitry may support being in the hazard checking state in respect of a subset of the delegated tasks, and not in the hazard checking state in respect of other delegated tasks.

A programmer may be provided with control over entry into the extension hazard checking state in respect of a particular delegated task through use of an instruction. For instance, decoder circuitry associated with the processor pipeline may be configured to be responsive to an extension hazard checking start instruction to generate control signals to command the processing pipeline to enter the extension hazard checking state in respect of the delegated task.

The extension hazard checking start instruction could be an instruction which, when executed at any point in a program, such as whilst the extension circuitry is performing the delegated task, causes the pipeline to enter the hazard checking state in respect of the delegated task. The instruction could be associated with a particular delegated task via a parameter (e.g., a TE identifier identifying the particular TE for which it is desired that hazard checking is performed). However, it has been identified that a programmer may know in general whether a delegated task can be performed in its entirety without risk of data hazards, and thus at the point of starting a delegated task generally knows if hazard checking will be required during performance of said delegated task. Thus, it can be helpful to enter the hazard checking state in respect of the delegated task when starting said delegated task. To reduce the number of instructions to be executed on starting such a task, the extension hazard checking start instruction may be the extension start instruction, such that the extension processing circuitry is configured to both start the delegated task and enter the extension hazard checking state in respect of that delegated task, in response to the decoding circuitry decoding the extension hazard checking start instruction.

When the extension hazard checking instruction causes entry into the extension hazard checking state in respect of a particular delegated task, the hazard detection circuitry is provided with access to the grouped address indicating data indicating which addresses are anticipated to be accessed by the extension processing circuitry during performance of said delegated task. This is to allow the hazard detection circuitry to compare addresses of subsequent memory accesses with said group(s) of addresses to determine if a data hazard condition is present. The hazard detection circuitry may be configured to access this information from some known location, such as a location to which the grouped address indicating data has been stored in advance by the processing pipeline. For example, the information could be stored in a control register accessible by the hazard detection circuitry. However, in some examples the grouped address indicating data may be specified by the extension hazard checking start instruction. It may be particularly efficient to specify the grouped address indicating data using the extension hazard checking start instruction when said instruction also causes the delegated task to begin. For example, the extension start variant of the extension hazard checking start instruction may, in the process of describing the delegated task, specify some regions of memory as source and destination buffers of the delegated task, and said definitions of source and destination buffers may also be reused to define groups of addresses which the extension processing circuitry is anticipated to access when performing the delegated task.

The extension hazard checking start instruction may specify the grouped address indicating data in several ways. For example, the grouped address indicating data could be specified as immediate values in the encoding of the instruction. However, in practice the amount of encoding space in the instruction is limited, and it may be preferable to specify the grouped address indicating data by identifying at least one register, within a set of registers for holding data values on which the data processing operations are performed, whose content is to be used to determine the grouped address indicating data. In cases where the grouped address indicating data is identified by several parameters, which register stores which parameter may be implicit in the encoding of the instruction (i.e., the register identified in a particular field of the instruction may always be considered to store the same parameter). However, in other examples a further register may provide information identifying which parameter is stored in which identified register. This may arise because there could be two different application programming interfaces (APIs): one matching the function signature of the delegated task, and another indicating the parameters which can be used by the hazard detection circuitry. It may be advantageous for the two APIs to be aligned, but they do not have to be and the further register may provide a mapping between the two APIs. The hazard detection circuitry may store within internal storage circuitry information defining one or more groups of addresses anticipated to be accessed by the delegated task, based on the information specified in the extension hazard checking start instruction.

In some cases, a group of addresses anticipated to be accessed by the extension processing circuitry whilst performing the delegated task may be described using a range of addresses in memory. There are several workloads which could be delegated to extension processing circuitry where source and destination buffers may be described as ranges. Whilst not every address in the range may actually be accessed, describing the group as a range can be particularly efficient for performing the hazard checks because it can be determined whether there is a potential data hazard using up to two comparisons (a first comparison with the first address in the range and a second comparison with the last address in the range), rather than comparing an address with many different discontiguous addresses. In addition, less storage may be required to define a range of addresses rather than, for example, keeping a record of many different groups of addresses. When a group of addresses anticipated to be accessed by the extension processing circuitry is a range of addresses, in one example implementation the address indicating data may comprise a first parameter and a second parameter, where at least one of the first parameter and the second parameter provides an address indication, and the first and second parameters are used in combination to determine a start address and size of the range. For example, the first and second parameters may be first and last addresses in the range. Alternatively, they may specify an address (such as the first address in the range, a last address, some intermediate address, or even an address some predetermined distance outside of the range) and a parameter describing the size of the range. The hazard detection circuitry may compute a range based on the two parameters, for example by calculating a last address if this is not included in the two parameters.

The inventors have realised that there are some delegated tasks where, as the task progresses, it can be determined that a particular address will not be accessed again. For example, some delegated tasks involve a linear data stream (which may be referred to as a channel) in which addresses in a source buffer are read a certain number of times, and addresses in a destination buffer are written to a certain number of times. After being read from or written to a certain number of times, it can be determined that a given address may not be accessed again by the extension processing circuitry. When such tasks are being performed, the risk of a data hazard may go away for addresses which have already been accessed the certain number of times by the extension processing circuitry, as memory accesses associated with subsequent instructions can no longer access those addresses before the extension processing circuitry. Hence, hazard checking may be relaxed in respect of addresses which will not be accessed again as part of the delegated task.

Given the above, in one example implementation the extension processing circuitry may be configured to maintain a progress indicator indicating a subset of addresses which have been accessed the certain number of times during performance of the delegated task, and are not expected to be accessed again during the delegated task. A progress indicator may only indicate that an address has been accessed at all when that address has been accessed the certain number of times and is not expected to be accessed again by the extension processing circuitry. If an address of a subsequent memory access would fall within a group of addresses anticipated to be accessed by the delegated task, the hazard detection circuitry can compare the address against the progress indicator to determine whether said address has already been accessed the certain number of times by the extension processing circuitry and if so, then it can be determined that a data hazard is not likely to arise. Thus, the progress indicator can be used to remove false positives from the set of accesses that would be identified using the grouped address indicating data indicating addresses anticipated to be accessed by the extension processing circuitry. This can improve performance since data hazard resolving actions which may have a high performance impact, such as stalling the CPU to allow the delegated task to complete, can be avoided in cases where they are not actually necessary (but would appear to be necessary without any knowledge of the progress of the delegated task).

In one example, the progress indicator may comprise bits corresponding to addresses, with the value of the bit indicating whether the corresponding address has been accessed the certain number of times or not. However, in some examples, addresses may be accessed in a predetermined order. In such cases, a more scalable progress indicator (whose size does not depend on the size of the group of addresses anticipated to be accessed) could be a pointer to a single address in memory, with each address in the group of addresses preceding the pointer address in the predetermined order being considered to have been accessed the certain number of times by the extension processing circuitry during execution of the delegated task, and each address following the pointer still anticipated to be accessed. The address indicated by the pointer could be considered to be the most recent address which has been accessed, or the address which has not been accessed but is anticipated to be accessed next.

The hazard detection circuitry may compare a candidate address against one or both of a group of addresses anticipated to be read by the delegated task, and a group of addresses anticipated to be written to by the delegated task. In such cases, different progress indicators may be maintained for each of the read group and the write group. However, even when there are independent read and write groups, there may be cases where there is a single progress indicator applying to both groups when data accesses are anticipated to be at the same relative point in each group (e.g., memcpy may be expected to have written to essentially the same number of locations it has read from).

In some examples, the hazard detection circuitry is configured to access state defining a write group of memory addresses to which the extension processing circuitry is anticipated to write data during performance of the delegated task. For example, the hazard detection circuitry may keep a record of the part of the grouped address indicating data which indicates addresses anticipated to be written to during performance of the delegated task. The hazard detection circuitry may also access a write progress indicator, as described above, indicating a subset of write addresses within the write group to which data has been written by the extension processing circuitry during performance of the delegated task. Keeping track of a write group of memory addresses (and a write progress indicator for filtering said write group) can be useful for identifying write-after-write and read-after-write data hazards, as will be discussed below.

The hazard detection circuitry may be configured to detect a read-after-write hazard condition in response to determining that the given memory access instruction is for reading data from the given address at a position in the write group which is indicated by the write progress indicator as an address to which data has not yet been written by the extension processing circuitry. When a memory access instruction later in the program order than the extension start instruction reads from a location which is a destination location of the delegated task, then the correct order of operations would involve the delegated task writing to the location before the subsequent read instruction reads from the location. The read-after-write hazard arises when, instead, the subsequent read is attempted before the delegated task has written to the given memory address. If the subsequent read were allowed to progress, it would read out of date information which would lead to incorrect results. It will be appreciated that “read instruction” is intended to mean any instruction which causes data to be read from a location in memory.

When the read-after-write hazard condition is detected, the hazard detection circuitry may be configured to perform a hazard resolution action by suppressing at least a first attempt by the processing pipeline to read data from the given address. This may prevent the subsequent memory access instruction from reading the data at the given address until the delegated task has progressed to the point where the extension processing circuitry has written the correct value to the given address. A subsequent attempt by the processing pipeline to read data from the given address may be allowed at a point where it is determined that the read-after-write hazard is no longer present. In some examples, a simple way to implement this check may be to allow the subsequent attempt only when the delegated task has completed. However, this risks delaying the read instruction (and subsequent dependent instructions) unnecessarily because preventing an attempt to read from the given address is no longer necessary after the extension processing circuitry writes to the given address and removes the data hazard. Hence, in some examples, a subsequent attempt by the processing pipeline to read data from the given address may be allowed in response to determining that the write progress indicator indicates that the given address is an address to which data has been written by the extension processing circuitry during performance of the delegated task.

Nevertheless, delaying the read instruction (in essence, stalling the processing pipeline) until the given address has been written to by the extension processing circuitry may still affect performance. Although, in general, there is little that can be done about this delay as it may typically be required to wait for the data to be generated by the delegated task before it can be read, the inventors have identified a case where this performance reduction can be mitigated. In particular, a memcpy function involves the movement of data from a first region of memory to a second region of memory, and therefore if the delegated task is memcpy and the data which is to be read is in the destination buffer of memcpy, then this data is actually already present in memory, albeit in the incorrect location (the source buffer). Rather than waiting for the delegated task to progress to the point where the relevant data has been moved from the source buffer to the destination buffer before performing the subsequent read, the read can be translated so that the given address (in the write group, a destination buffer of the memcpy function) is translated to the corresponding address in the source buffer at a location which will be copied to the given address. Then, a read request may be issued to access the data from the corresponding address in the source buffer of the memcpy function, and therefore the data hazard can be resolved without waiting for the delegated task, and the pipeline does not have to be stalled. This technique is of course not limited to memcpy, and may be used in general where data is moved from one location in memory to another, and a read from a destination location can be translated to be a read from a source location (e.g., the delegated task may be duplicating data from one location to many locations, transposing a matrix, copying strings, network packet processing, etc.).

The hazard detection circuitry may be configured to detect a write-after-write hazard condition in response to determining that the given memory access instruction is for writing data to the given address at a position in the write group which is indicated by the write progress indicator as an address to which data has not yet been written by the extension processing circuitry. When a memory access instruction later in the program order than the extension start instruction writes to a location which is a destination location of the delegated task, then the correct order of operations would involve the delegated task writing to the location before the subsequent write instruction writes to the location. The write-after-write hazard arises when, instead, the subsequent write is attempted before the delegated task has written to the given memory address. There is a risk that the delegated task, earlier in the program order, would then overwrite the data written by the write instruction later in the program order. It will be appreciated that “write instruction” is intended to mean any instruction which causes data to be written to memory.

An approach to handling a write-after-write hazard condition would be to stall the pipeline until the delegated task has completed. However, this may not be necessary to deal with a write-after-write hazard, because the subsequent write (unlike a read) is not directly dependent on the write of the delegated task. In other words, the data processing pipeline does not require the data to have been written to the given address by the delegated task before it performs its own write, and so instead of stalling the pipeline it may be more efficient to allow the write of the subsequent memory access instruction (and therefore any subsequent instructions) to proceed and then prevent the delegated task from overwriting the written data with out-of-date data.

Hence, the hazard detection circuitry may be responsive to detection of the write-after-write hazard to perform the hazard resolution action by causing an indication of the given address to be stored in a write address storage element associated with the extension processing circuitry, and allowing execution of the given memory access instruction to proceed in order to cause the data to be written to the given address. Then, responsive to determination that a delegated write memory access is to be performed by the extension processing circuitry during performance of the delegated task to an address indicated in the write address storage element, the extension processing circuitry is configured to prevent the delegated write memory access from being performed. The write address storage element therefore essentially tracks addresses to which data has already been written in response to instructions following the extension start instruction in the program order, and indicates which addresses the delegated task should not attempt to overwrite with out-of-date data.

The write address storage element may take a variety of forms, but in one example implementation may be an entry in a write address buffer provided within the extension processing circuitry. Providing the write addresses in a buffer can allow the extension processing circuitry to quickly determine whether outgoing write requests are to an address indicated in the write address storage element, and therefore prevent those write requests from happening if required, whilst reducing delays to those writes (which could in turn cause delays to reads from the address to be written to). However, the write address buffer may have a limited number of entries. When the write address buffer is full, the hazard resolution action may revert to stalling the pipeline, which impacts performance. Therefore, it would be desirable to evict entries from the write address storage buffer when they are no longer required. In particular, this can be determined when the write progress indicator is updated to indicate that an address associated with a given entry of the write address storage buffer is an address to which data has been written (or at least, attempted to be written) by the extension processing circuitry during performance of the delegated task (and therefore may not be written to again, meaning that retaining an indication of the address is unnecessary). The extension processing circuitry may hence be configured to invalidate said write address storage element (e.g., buffer entry) when it is detected that the entry is no longer required. One example technique would be to invalidate an entry in response to that entry being used to prevent a delegated write from being performed (indicating that said entry has done its job and is no longer required).

In some examples, the hazard detection circuitry is configured to access state defining a read group of memory addresses from which the extension processing circuitry is anticipated to read data during performance of the delegated task. The hazard detection circuitry may also access a read progress indicator, as described above, indicating a subset of read addresses within the read group from which data has been read by the extension processing circuitry during performance of the delegated task. Accessing a read group of memory addresses (and a read progress indicator for filtering said read group) can be useful for identifying write-after-read data hazards, as will be discussed below.

The hazard detection circuitry may be configured to detect a write-after-read hazard condition in response to determining that the given memory access instruction is for writing data to the given address at a position in the read group which is indicated by the read progress indicator as an address from which data has not yet been read by the extension processing circuitry. When a memory access instruction later in the program order than the extension start instruction writes to a location which is a source location of the delegated task, then the correct order of operations would involve the delegated task reading from the location before the subsequent write instruction writes to the location. The write-after-read hazard arises when, instead, the subsequent write is attempted before the delegated task has read from the given memory address. If this were allowed to take place as normal, then the extension processing circuitry would read incorrect data for the delegated task as it would read data that was written in response to an instruction later in the program order, which should not have been written yet at the time of the read of the delegated task.

An approach to handling a write-after-read hazard condition would be to stall the pipeline until the delegated task has completed. However, this may not be necessary to deal with a write-after-read hazard, because (in a similar way to a write-after-write hazard) the subsequent write is not directly dependent on the read of the delegated task. In other words, the data processing pipeline does not require the data to have been read from the given address by the delegated task before it performs its own write, and so instead of stalling the pipeline it may be more efficient to allow the write of the subsequent memory access instruction (and therefore any subsequent instructions) to proceed. In order to enable this whilst also allowing the extension processing circuitry to read correct data, some examples may provide a read data storage element in which the “old” read data (prior to being updated in response to the subsequent write instruction) can be stored, to be read by the extension processing circuitry, whilst allowing the location in memory to be updated in response to the later write instruction to store the “new” data, which can then be accessed by any following instruction.

Therefore, in some examples, responsive to detection of the write-after-read hazard condition, the hazard detection circuitry is configured to perform the hazard resolution action by causing a copy of read data, from the given address in memory, to be stored in a read data storage element associated with the extension processing circuitry, and then allowing execution of the given memory access instruction to proceed in order to cause the write data to be written to the given address. Responsive to determination that a delegated read memory access to be performed by the extension processing circuitry during performance of the delegated task is to an address for which read data is stored in the read data storage element, the extension processing circuitry may then perform the delegated read memory access by accessing the read data storage element, rather than the address in memory.

In a similar way to the write address storage element, the read data storage element may be an entry in a read data buffer associated with the extension processing circuitry. Providing the read data in a location such as a buffer which is quick to access by the extension processing circuitry means that delays to processing of the delegated task associated with checking and/or accessing data from the read data buffer can be reduced. It would be desirable to evict entries from the read data storage buffer when they are no longer required. In particular, this can be determined when the read progress indicator is updated to indicate that an address associated with a given entry of the read data storage buffer is an address from which data has been read (or at least, attempted to be read) by the extension processing circuitry during performance of the delegated task (and therefore may not be read from again, meaning that retaining a copy of the old read data is unnecessary). The extension processing circuitry may be configured to invalidate said read data storage element (e.g., buffer entry) when it is detected that the entry is no longer required. One example technique would be to invalidate an entry in response to that entry being used to provide read data to a delegated read performed by the extension processing circuitry (indicating that said entry has done its job and is no longer required).

It has been discussed above how the processing pipeline may enter the extension hazard checking state in respect of the delegated task. In a similar way, the processing pipeline may exit the extension hazard checking state in respect of the delegated task. For example, when the extension hazard checking state is exited, the hazard detection circuitry may invalidate state defining the anticipated accesses, and stop checking whether addresses of subsequent memory accesses are for accessing data from an address anticipated to be accessed by the extension processing circuitry. In one example implementation, this may be performed in response to an explicit extension hazard checking exiting instruction. However, in a similar way to how entering the hazard checking state can be tied to starting a delegated task, the processing pipeline may be configured to exit the extension hazard checking state in respect of a particular delegated task in response to completion of said delegated task. It can be determined that a delegated task has completed in several ways. For example, a “complete” signal may be asserted when the delegated task is complete. Alternatively, an instruction may be executed to return a value depending on whether the delegated task has completed. Further, if read and/or write progress indicators are provided then it may be determined that a delegated task is completed when the progress indicators indicate that all addresses anticipated to be accessed have indeed been accessed by the delegated task.

In some examples, the assumption that the delegated task will read and write exclusively to some predefined groups of memory addresses such as the source and destination buffers may not hold. In these cases, the above described technique can still be used to but may be supplemented by capturing read and write sets for those data accesses outside of the anticipated groups of addresses.

In cases where read and write sets may still be captured to some extent, storing the large amount of state required to track the memory accesses may become onerous. Similarly, in the examples described above where read data may be stored in a read data storage element in response to detection of a write-after-read hazard and/or write addresses may be stored in a write address storage element in response to a write-after-write hazard, the amount of state to be maintained in said elements may become quite large. Generally, there may be cases where the amount of storage required to store state for hazard checking exceeds some fixed threshold. In these cases, the pipeline may be caused to stall until the required space is made available (e.g., by invalidating storage elements when the progress indicator is updated). In some situations these stalls may become frequent and detrimental to performance.

Therefore, the inventors have recognised that there is scope for additional instructions which can be used by programmers to ease the burden on the hazard detection hardware by indicating regions of code where some hazard checking can be relaxed. This can reduce the amount of state that may be tracked and reduce the likelihood of pipeline stalls. This arises out of the observation that although it may be difficult to determine exact producer-consumer relationships in code (hence not relying on the programmer to prevent all data hazards, as discussed above), the programmer may nevertheless be capable of spotting pockets of unrelated functionality where they can be confident that hazard checking is not required.

The decoder circuitry may therefore be responsive to an extension hazard checking moderating instruction to generate control signals to selectively alter operation of the hazard detection circuitry in respect of determining the presence of the hazard condition for at least one type of memory access instruction following the extension start instruction in the program order.

A first encoding of the extension hazard checking moderating instruction may cause the hazard detection circuitry to disable hazard checking for at least one type of memory access. The first encoding of the instruction may be identified based on a unique opcode which identifies the instruction as a first encoding of the extension hazard checking moderating instruction. Alternatively, a parameter specified by a more general extension hazard checking moderating instruction may identify the instruction as a first encoding of said instruction (as will be discussed below, there may also be a second encoding which can be similarly identified).

Different variants of the first encoding of the moderating instruction may disable hazard checking for only reads, only writes, or both reads and writes, allowing the programmer to have increased control over disabling of hazard checking. For example, there may be a region of code where the programmer is confident that reads will not encounter data hazards, but where there is a possibility that writes will, and hence hazard checking can be disabled for reads only (and vice versa).

A second encoding of the extension hazard checking moderating instruction may cause the hazard detection circuitry to enable hazard checking for at least one type of memory access. This may involve re-enabling hazard checking that had previously been disabled by a moderating instruction having the first encoding, or involve enabling hazard checking that was never enabled in the first place (e.g., if the hazard checking state was entered in respect of only one type of memory access). Like the first encoding of the moderating instruction, variants of the second encoding may enable hazard checking for reads only, writes only, or both, to provide an increased level of control.

Particular examples will now be described with reference to the Figures.

FIG. 1 schematically illustrates a data processing apparatus 10 according to some examples. The data processing apparatus 10 is schematically shown to have a pipelined configuration, which for the purposes of brevity and clarity is shown in a conceptual representation here. The illustrated pipeline stages comprise an instruction cache 11, a fetch stage 12, a decode stage 13, a micro-op cache 14, an issue stage 15, and a register access stage 16. A sequence of instructions is retrieved from memory (not shown) and cached in the instruction cache 11. The fetch stage 12 controls which instructions are retrieved as the sequence of instructions and these instructions are then decoded in the decode stage 13. This decoding essentially identifies the type of each instruction, as well as any further operands specified by the instruction, and generates control signals to control the remainder of the apparatus to perform the data processing operation(s) defined by the instruction. Decoding the instructions may comprise splitting an instruction into one or more micro-ops, and these micro-ops can be cached in the micro-op cache 14. The final stage of the pipeline before execution is the issue stage 15, where instructions (or micro-ops) are queued pending the availability of the register values they specify as operands and the corresponding functional unit of the data processing pipeline which will carry out the defined operation. Generally the data processing operation(s) defined by the instructions are carried out by the functional units that form part of the data processing pipeline, namely the load/store unit 17, the execute unit 18, and the execute unit 19. These latter execute units may for example be arithmetic logic units (ALUs), floating point units (FPUs), and so on. The functional units that form part of the data processing pipeline perform their data processing operations on data values which are provided from a set of registers (conceptually represented by the register access stage 16 in the figure) and result values of those data processing operations are returned to the set of registers. The load/store unit 17 is provided for the purpose of storing values from the set of registers to the memory system, of which only a level 1 cache 21 and a level 2 cache 22 are shown in the figure. The L1 cache 21 is private to the data processing apparatus 10 and the L2 cache 22 may be shared with another data processing apparatus, when part of a wider data processing system. The data processing apparatus 10 is also shown to comprise a branch unit 20, which monitors execution flow of the sequence of instructions and seeks to predict, based on previous execution history, whether a given branch will be taken or not. The predictions from the branch unit 20 inform the sequence of instructions caused to be fetched by the fetch stage 12.

The data processing apparatus 10 further comprises extension processing circuitry 23, which is provided to support efficient performance of one or more defined functions, which have been established to be impactful and ubiquitous for the data processing operations which this data processing apparatus 10 carries out. Example functions of this type have been found to include tasks or functions such as memcpy, memset, compression, encryption, and string processing, although the present techniques are not limited to these particular examples. The extension processing circuitry is closely associated with the data processing pipeline and is configured to perform the defined function (also referred to herein as a delegated task) in response to a delegation signal received from the data processing pipeline. The extension processing circuitry 23 is an example of a threadlet extension (TE) according to the present techniques. The sequence of operations it carries out to perform the defined function is referred to as a threadlet herein. The extension processing circuitry 23, although closely associated with the data processing pipeline, is configured to perform the delegated task asynchronously to the data processing operations performed by data processing pipeline. The data processing pipeline may also be referred to as the CPU herein. Threadlets are functions or collections of operations that can be executed asynchronously relative to other CPU activity once launched. The directive or command sent to the extension processing circuitry 23 to initiate the delegated task is generated in response to an extension start instruction defined for this purpose in the instruction set of the data processing pipeline. Thus, an extension start instruction progresses along the data processing pipeline in the manner that any other CPU instruction would, but when the decoding circuitry 13 identifies the extension start instruction it can signal directly to the extension processing circuitry 23. The close integration of the extension processing circuitry 23 with data processing pipeline is illustrated by the fact that the extension processing circuitry 23 has direct access to the load/store unit 17, and thus it shares the data processing pipeline's path to memory. The extension processing circuitry 23 also has access to the set of registers 16, such that for example, the extension start instruction can specify one or more registers as operands, and the values from these registers are then passed directly to the extension processing circuitry 23 in association with the command sent to initiate the delegated task. Upon completion of the task, results of the delegated task can be returned to the register values via an extension synchronisation instruction.

FIG. 2 schematically illustrates a data processing apparatus 30 according to some examples. It will be noted that the arrangement of components of the data processing apparatus 30 is similar to that of the components of the data processing apparatus 10 shown in FIG. 1. One difference is that whilst the data processing apparatus 10 of FIG. 1 is intended to represent an in-order processor, the data processing apparatus 30 is an out-of-order processor. As one consequence of this the data processing pipeline of the data processing apparatus 30 comprises a rename stage 35, allowing the data processing apparatus 30 to vary the order in which it executes instructions of the sequence of instructions, such that they can be executed in an order dictated by when their operands become available, and the availability of functional units, rather than the order in which they appear in the sequence. The illustrated pipeline stages comprise an instruction cache 31, a fetch stage 32, a decode stage 33, a micro-op cache 34, the rename stage 35, an issue stage 36, and a register access stage 37. A sequence of instructions is retrieved from memory (not shown) and cached in the instruction cache 31. Instructions pass through the data processing pipeline in the manner described above with reference to the data processing apparatus 10 of FIG. 1, with the further register renaming that is performed by the rename stage 35. The functional units of the data processing pipeline in this example are the load unit 38, the store unit 39, the FPU 41, the integer ALU 42, and the vector unit 43. The throughput of the FPU 41, the integer ALU 42, and the vector unit 43 is sufficient that a result cache 44 is provided an intermediary before results of their data processing are returned to the registers 37. A branch prediction unit 45 is also provided and its predictions inform the operation of the fetch stage 32.

The data processing apparatus 30 further comprises extension processing circuitry (“threadlet extension”) 49, which is provided to support efficient performance of one or more defined functions, which have been established to be impactful and ubiquitous for the data processing operations which this data processing apparatus 30 carries out. The extension processing circuitry 49 is closely associated with the data processing pipeline and is configured to perform the defined function in response to a delegation signal received from the data processing pipeline. In the example of FIG. 2, this delegation signal is shown emanating from the issue queue stage 36. Notably, this is after the rename stage 35, such that the extension processing circuitry 49 can operate with respect to the physical registers of the set of registers 37 according to the same mapping of architectural registers used for the rest of the apparatus. As in the example of FIG. 1, the data processing pipeline (instruction cache 31 through to the register read stage 37, the load/store units 38 and 39, and the functional units 41-45) may also be referred to as the CPU. The threadlet extension 49 operates asynchronously relative to other CPU activity once launched. The directive or command sent to the extension processing circuitry 49 to initiate the delegated task is generated in response to an extension start instruction defined for this purpose in the instruction set of the data processing pipeline. The close integration of the extension processing circuitry 49 with data processing pipeline also apparent in this example by the fact that the extension processing circuitry 49 has direct access to the load unit 38 and the store buffer 40, and thus it shares the data processing pipeline's path to memory. The extension processing circuitry 49 also has access to the set of registers 37, such that for example, the extension start instruction can specify one or more registers as operands, and the values from these registers are then passed directly to the extension processing circuitry 49 in association with the command sent to initiate the delegated task. Note that the output of the branch prediction unit 45 is also provided to the extension processing circuitry 49. Upon completion of the task, results of the delegated task can be returned to the register values via an extension synchronisation instruction.

FIG. 3 schematically illustrates a data processing apparatus 50 according to some examples. This example provides a comparison to the examples of FIG. 1 and FIG. 2, in which examples the extension processing circuitry was closely embedded with the data processing pipeline, to the extent that those instances of extension processing circuitry may be considered to be within the CPU. In the example apparatus 50 of FIG. 3, the CPU 51 and the extension processing circuitry (threadlet extension) 52 are not as closely integrated. For example this is illustrated by the fact that each has its own path to memory, with an L1 cache 53 private to the CPU 51 and an L1 cache 54 private to the threadlet extension 52. They share the L2 cache 55. Nevertheless, the threadlet extension 52 remains tightly coupled to the CPU 51, and can be launched quickly when an extension start instruction is encountered in the CPU pipeline specifying the function this threadlet extension 52 performs. The threadlet extension 52 can get data directly from CPU registers at the start of its execution. Upon completion, it can return values via an extension synchronisation instruction. FIG. 3 also shows the threadlet extension 52 as having its own private TLB 56, in which it can cache currently used address translations. As a preparatory step before or associated with the delegation signal, content from the TLB 57 in the CPU 51 can be copied into the private TLB 56 in order to pre-warm this cache before the threadlet begins operation.

FIG. 4 is a state diagram illustrating an example set of states between which an extension processing circuitry (TE) transitions in some examples. Initially the TE is in an IDLE state 60. When an extension start (XSTART) instruction is encountered by the data processing pipeline, a delegation signal can cause the TE to switch to the SETUP state 61. This may also require a signal indicating that the XSTART instruction has been committed to be asserted. In the SETUP state 61, certain actions necessary for preparing the TE can be performed, for example, in examples in which the TE has a separate path to memory (as in the case of FIG. 3), one setup task is the transfer of relevant entries currently in the CPU's TLB to a private TLB within the TE. This enables the TE to perform translations independently at a faster rate than if it were to rely entirely on the existing translation mechanism within the CPU. If the TE has been in a clock-gated or power-gated condition when in the IDLE state 60, the SETUP state 61 may also comprise the task of exiting the TE from that clock-gated or power-gated condition. Once the SETUP state 61 is complete the TE can switch to the RUNNING state 62. If the TE encounters a memory fault during its processing, it asserts a signal which will raise an interrupt within the CPU, causing it to stop executing the main thread and switch to a handler. The TE switches to the INTERRUPTED state 63. An indication of the source of the fault is placed in a special syndrome system register, the address associated with the fault is stored in the fault address system register, and a bit in the Program Status Register (PSR) will be set enabling the handler to quickly determine the source of the fault. Setting a bit in the PSR makes communicating the resumption of the threadlet straightforward, because the handler can reset the relevant bit in the SPSR and when the CPSR is restored from the SPSR during exception return, the TE can detect the resetting of this bit and resume executing. The TE will also switch to the INTERRUPTED state 63 if the main thread gets switched out, e.g. during a context-switch initiated by the operating system. In the INTERRUPTED state 63, the TE may be clock-gated or power-gated, unless some other thread launches a new command directed at it or the associated thread returns resumes execution or the handler returns. The TE returns from the INTERRUPTED state 63 to the RUNNING state 62 via the RELOAD state 64 in which any context or state relevant to its execution, which was previously saved to memory, can be restored. This might be the case if another thread made use of a TE which was previously interrupted. Finally, when the extension reaches the end of the offloaded granule of computation (the delegated task) it moves to the IDLE state 60. The TE will advertise completion of the task, so that an extension synchronisation instruction (XSYNC) can pick up that “done” signal and, if required, provide a return value to a specified register. If the TE has any lingering data in its private caches it might also need to flush these entries upon completion.

An example of using threadlets is now set out. The programmer or compiler identifies functions whose execution in custom hardware (extension processing circuitry) satisfies the cost-benefit thresholds in their use-case. An instruction (such as XSTART) is used to launches a command within the designated CPU extension. An example use written in pseudo-code (for such an identified function “funcX”) is as follows:

```
funcA ( ) {
  . . .
  XSTART {x0 − x3}, #imm_op //funcX(a, b, c, d);
  I1
  I2
  I3
  I4
  . . .
  XSYNC x0, #imm_op
  . . .
}
```

Thus, within the function funcA, the XSTART instruction initializes the CPU extension and transfers to the extension processing circuitry the parameters (a, b, c, d) for funcX, which are in registers x0, x1, x2, x3 respectively. The XSTART instruction in this example also specifies the immediate value #imm_op, which defines the specific function to be carried out. For example, whilst there might only be one instance of extension processing circuitry, it may be capable of performing more than one function, or at least more than one variant of a function, and the immediate value #imm_op can select the desired variant and/or function. In other examples there may be more than one instance of extension processing circuitry and the immediate value #imm_op can select between them. Depending on the setup, the extension could also automatically get a copy of relevant entries in the TLB. The extension processing circuitry then carries out the task required (funcX) and during its execution, the CPU is free to carry on executing other instructions I1, I2, I3, I4, etc. At some point in the future, the CPU executes an extension synchronisation instruction (XSYNC) which automatically checks whether the extension has completed or not. If it has not, for some variants of the extension synchronisation instruction, the CPU will wait for the delegated task to complete. Other variants of the extension synchronisation instruction (e.g. the XSYNCS variant) allow the CPU can carry on executing other code (if there are alternative routines available or stop executing and wait for completion of the extension (typically if there is nothing else to execute in the interim). There are a range of variations of XSTART and XSYNC proposed herein, and these are discussed in more detail with reference to the figures which follow.

FIG. 5 schematically illustrates an extension start instruction delegating a task to extension processing circuitry in accordance with some examples. Here the XSTART instruction takes the form: XSTART {x0-x7}, #imm. Thus an XSTART instruction 100 of this form, when decoded by the CPU's decoder 101, causes the content of registers x0-x7 to be retrieved from the registers 102 and passed to the extension processing circuitry 103. In this case the extension processing circuitry 103 can perform multiple types of operation (task) and the immediate value #imm (or signals based on the immediate value #imm) selects between them.

FIG. 6 schematically illustrates an extension start instruction delegating a task to one of several instances of extension processing circuitry in accordance with some examples. Here, the XSTART instruction also takes the form: XSTART {x0-x7}, #imm. However in this example, there are multiple instances of extension processing circuitry and the immediate value #imm is used to select between them. Thus an XSTART instruction 105 of this form, when decoded by the CPU's decoder 106, causes the content of registers x0-x7 to be retrieved from the registers 102. Extension control circuitry 108, on the basis of the immediate value #imm (or signals based on the immediate value #imm) directs the register values to the selected extension processing circuitry 110. In this case, the other instances of extension processing circuitry 109 and 111 are not activated by this instruction.

FIG. 7 schematically illustrates the data processing apparatus 50 as illustrated in FIG. 3, on which circuitry related to hazard detection has been illustrated. In particular, hazard detection circuitry (also referred to as collision detection and resolution (CDR) circuitry) 58, a read data storage buffer 590, and a write address storage buffer 591 have been illustrated. It will be appreciated that such circuitry is not limited to the example of FIG. 3, and similar circuitry could be provided in the examples of FIGS. 1 and 2, for example.

Provision of the CDR 58 allows code following an extension start instruction in program order to be executed by the CPU 51 (or processing pipeline in more tightly coupled examples) whilst the TE 52 is executing a threadlet, even in cases where that subsequent code may include memory accesses to addresses which are also to be accessed by the threadlet. In a typical approach where memory accesses are expected to take place according to the program order, the memory accesses associated with the threadlet would be expected to take place before any memory accesses associated with the subsequent instructions. However, as the TE 52 executes the threadlet asynchronously with respect to the CPU 51, the actual point that certain memory accesses are performed by the TE 52 may be difficult to predict and may vary between different instances of executing the same code, and in any case may be after the subsequent instruction has been executed. Besides writing code to prevent subsequent memory accesses from being performed until the threadlet has finished, an approach to addressing the potential for data hazards could be to track sets of writes and reads made by the TE 52 and CPU 51 whilst the threadlet is being performed, and compare the read and write sets to identify data hazards (data accesses performed to the same address out of program order). However, this can require storage of a large amount of state, undesirable due to at least the hardware requirements for storage and the latency added to context switches, and does not scale well for large threadlets. The inventors have observed that tasks to be delegated as threadlets may have data access patterns which enable use of a lower overhead hazard detection scheme, because it can often be anticipated in advance which addresses a particular threadlet will access. For example, if a task having a well-defined source buffer and destination buffer, such as memcpy, is delegated as a threadlet, it can be anticipated that the threadlet will access the source buffer and the destination buffer of the function. The CDR 58 can take advantage of the anticipated accesses by identifying a potential data hazard based on whether an instruction following the extension start instruction in program order requires a memory access to be performed to an address within a group of addresses anticipated to be accessed by the threadlet. If not, then that subsequent memory access may be allowed to proceed on the basis that the threadlet will not access the address, and therefore a data hazard will not arise (regardless of when the TE 52 actually performs the memory access).

In addition, a threadlet may also accesses addresses in channels, where each address is accessed in a well-defined order. For example, a task may perform some operation on each address in a region of memory, and may therefore access said region by reading the first address, performing the operation, reading the second address, performing the operation, and so on. Once an address has been accessed a certain number of times, it may therefore be inferred that such an address will not be accessed again, and therefore the set of addresses anticipated to be accessed by the threadlet can be filtered based on some indication of the progress of the threadlet. The TE 52 may therefore maintain one or more progress indicators indicating which of the anticipated addresses have actually been accessed, and indicating which addresses are anticipated to still be accessed, and the CDR 58 may have access to the one or more progress indicators. The threadlet extension 52 may comprise internal caches (which may typically be used to store values which need to be reused or replicated) which may be used to buffer writes emanating from execution streams within the TE and allow order to be restored before making any writes visible outside the TE, enabling the TE to externally adhere to channel semantics even if this is not always the case internally.

In at least one example, the CPU 51 is responsive to decoding a hazard checking variant (XSTARTN) of the extension start instruction to cause the TE 52 to begin a threadlet and the CPU to enter into a hazard checking state for that threadlet. Although not illustrated, there may be both blocking and non-blocking variants of the XSTARTN instruction which either prevent further execution or allow further execution of subsequent instructions in the event that the TE is unable to start the threadlet in response to the XSTARTN instruction. The XSTARTN instruction specifies (in addition to, or as part of, information identifying the delegated task) registers identifying groups of addresses which are anticipated to be accessed by the threadlet. The CDR 58 may compute ranges based on the data stored in the specified registers and store range information in local storage for use in hazard checking. When the CPU 51 executes an instruction after the XSTARTN instruction in the program order, the CDR 58 can determine whether the instruction is for a memory access to an address in a group of addresses anticipated to be accessed by the threadlet, and if so this may indicate a potential data hazard. The one or more progress indicators identifying how far the TE 52 is through a delegated task can be used when the CDR 58 identifies a potential hazard to filter out cases where no hazard actually arises due to the threadlet having already accessed the address in question. Examples are provided below.

One example encoding of the XSTARTN instruction has the following encoding:
XSTARTN x0, x1, x2, #imm, in which:
x0 identifies a register location containing a pointer to a region of memory defined as the destination buffer for the threadlet,
x1 identifies a register location containing a pointer to a region of memory defined as the source buffer for the threadlet,
x2 identifies a register location containing a parameter defining the size of the source and destination buffers, and
#imm is an immediate value providing a threadlet identifier.

It will be appreciated that this is merely an example which does not limit the technique. For example, a further parameter may identifier a second size parameter, where the source and destination buffers have different sizes. Also, the relative ordering of the registers may be different in different instances of the instruction. A register may, for example, provide information indicating which register stores which item of information. Also, rather than being provided in registers, certain parameters may be provided as immediate values in the encoding of the instruction. In some examples the read and write groups may not be ranges at all, and different information could be provided to identify which addresses are anticipated to be source addresses and which addresses are anticipated to be destination addresses for the threadlet.

In any case, in the present example the CDR 58 may compute a range of addresses from which the threadlet is anticipated to read and a range of addresses to which the threadlet is anticipated to write, as follows: read range={x1, x1+x2}, write range={x0, x0+x2}.

FIG. 8 is a flow diagram providing an example of execution of the XSTARTN instruction. At step 800, the CPU 51 executes the XSTARTN instruction. At step 802, in response to the XSTARTN instruction, the CPU 51 delegates a task to the TE 52, and as in above examples provides information identifying the task to the TE 52. As part of this information, grouped address indicating data is made available to the CDR 58, which at step 54 obtains the information and computes a group of read addresses and a group of write addresses (such as a read range and write range) which are anticipated to be read from or written to by the TE 52 when performing the delegated task. In addition, in response to the XSTARTN instruction, at step 806 the apparatus 50 enters the hazard checking state, meaning that at step 808 the CDR 58 begins detecting and handling data hazards between the delegated task started at step 802 and memory access instructions following XSTARTN in the program order. During progress of the threadlet, the CDR 58 monitors reads and writes issued by the TE 52, and uses the monitored memory accesses to update the read and write progress indicators indicating which addresses have been accessed during performance of the threadlet.

At step 810 it is determined whether the delegated task has completed execution on the TE 52. This may involve checking the progress indicators, which may indicate that all anticipated reads and writes have been performed and therefore that the threadlet is complete. Alternatively, this determination could be based on a signal asserted by the threadlet, or execution of an instruction such as XSYNC for determining if the threadlet is complete. If not, the CDR 58 continues to check for, and handle, hazards. If the threadlet is complete, then at step 812 the apparatus exits the extension hazard checking state in respect of the threadlet started at step 802. The apparatus may still be in the hazard checking state in respect of other threadlets, however.

The checks and actions performed by the CDR 58 at step 808 are elaborated in FIGS. 9 and 10, which are flow diagrams illustrating the process of checking for hazards associated with writes and reads appearing after the XSTARTN instruction in program order respectively.

At step 900 in FIG. 9, the decoder of the processing pipeline (or the CPU 51) encounters a write instruction appearing in the program order after the XSTARTN instruction whilst in the hazard checking state in respect of the delegated task started by said XSTARTN instruction. At step 902 it is checked whether, despite being in the hazard checking state, hazard checking has been disabled for writes in respect of the delegated task (which may occur, for example, in response to an XSYNCN instruction as will be discussed below). If so, then no hazard checking is performed in respect of the write instruction and the process moves to step 904 in which the write is allowed to proceed.

However, if hazard checking has not been disabled, then at step 906 the data associated with the write instruction is temporarily stored in a store buffer of the processing pipeline whilst hazard checking is performed.

At step 908 it is determined whether the write instruction is for performing a write to an address falling within a group of addresses from which the threadlet is anticipated to read data, such as a source buffer, as indicated by read group address indicating data. The group of addresses may in some examples be a range of contiguous addresses, but this is not required. If it is found that the write address does lie within a group of addresses anticipated to be accessed by the threadlet, then it is determined at step 910 whether the hazard is nonetheless not possible because the write address has already been read by the threadlet, as indicated by the read progress indicator. In cases where the read progress indicator is a pointer to a single address (on the assumption that addresses are accessed in order) then this may involve a comparison between the write address and the progress indicator to determine whether the progress indicator has progressed “ahead” of the write address or not. If the write address has already been read by the threadlet, then writing to that location will not impact which data the threadlet reads, and therefore the write may be allowed to proceed. This is an example of the read progress indicator being used to filter the set of memory accesses which at first appear to present a data hazard as the write address lies in the range of anticipated accesses by the threadlet, but in practice no longer present a hazard when the threadlet has progressed past a certain point of processing. Due to the asynchronous nature of the threadlet, it may not be known in advance at a given point of processing how far the threadlet is, and that is why the progress indicator may be used to determine whether a data hazard is present or not.

If at step 910 it is determined that the write address is an address from which the threadlet has not yet read data, then a write-after-read (WAR) hazard is identified. Writing to the write address at this point could cause the threadlet to read incorrect data (data generated by a write instruction later in the program order than the XSTARTN instruction) when it eventually performs its read (which should be performed, as far as the program is concerned, at the XSTARTN instruction). However, preventing the write could cause all subsequent instructions depending on that write data to be stalled, impacting performance. Therefore, at step 912 the data in memory at the write address, which the threadlet is yet to access, is stored in a read data buffer 590 associated with the TE 52. At step 914 the write is allowed to progress, overwriting the old value in memory. At step 916, any future reads by the TE 52 to the write address (which should be accessing the old data, as they are each associated with the point in program order prior to the subsequent write instruction) are redirected such that they read the old data stored in the read data storage element 590, rather than the new data in memory. When the read progress indicator is updated to indicate that the write address is an address from which the threadlet has read data, then the read data no longer needs to be stored in the read data store buffer 590, and therefore can be removed in step 918 from the read data storage element to free up space for additional entries.

If at step 908 it is instead found that the write address does not fall within the group of addresses anticipated to be read by the threadlet, then it is also determined whether the write address falls within the group of addresses anticipated to be written to by the threadlet as indicated by write group address indicating data. If not, then it may be determined that there is no risk of a WAR or a write-after-write (WAW) hazard, and therefore at step 904 the write may be allowed to proceed.

If, however, it is found that the write address does fall within the group of addresses initially anticipated to be read by the threadlet, then at step 922 it is determined whether the write progress indicator indicates that the threadlet has not yet written to the write address (which, in examples where the write progress indicator is a pointer to a single address, may be a determination of whether the write address is ahead of the write progress indicator due to lying in a region which has not yet been reached by the write progress indicator). If not, then the threadlet has already written to the write address, and therefore it may be unlikely that the threadlet will access that address again, and therefore unlikely that the write data will be overwritten with out-of-date data from the threadlet. Therefore, the write may be allowed to proceed.

If at step 922 it is found that the write address is an address which has not yet been written to by the threadlet, then a write-after-write hazard is identified. There is a risk that the threadlet (associated with the earlier XSTARTN instruction) could overwrite the write data associated with the later write instruction if the write instruction is performed at that point. However, it would be desirable to allow the write to be performed so that subsequent instructions may access the write data in memory. Hence, at step 924, an indication of the write address is stored to a write address storage element 591, and the write is allowed to progress at step 926. The write address storage element 591 is used to prevent writes, to be performed as part of the threadlet, from overwriting newer data written to memory in response to write instructions later in the program order. Hence, if a write is to be issued by the threadlet to an address indicated in a write address storage element 591, then that write is prevented from taking place. After the write progress indicator progresses past a particular address (such as by the TE attempting to write to that address) then the corresponding write address storage element 591 may be invalidated on the assumption that the address will not be accessed again, to free up space in the write address storage buffer 591.

FIG. 9 therefore demonstrates the use of grouped address indicating data indicating anticipated read and write accesses by a threadlet for identifying and resolving hazards between said threadlet and data processing operations after the threadlet start instruction in program order, when said data processing operations are performed at the same time as, and asynchronously to, the threadlet.

At step 1000 in FIG. 10, the decoder of the processing pipeline (or the CPU 51) encounters a read instruction appearing in the program order after the XSTARTN instruction whilst in the hazard checking state in respect of the delegated task started by said XSTARTN instruction. At step 1002 it is checked whether, despite being in the hazard checking state, hazard checking has been disabled for writes in respect of the delegated task (which may occur, for example, in response to an XSYNCN instruction as will be discussed below). If so, then no hazard checking is performed in respect of the read instruction and the process moves to step 1004 in which the write is allowed to proceed.

However, if hazard checking has not been disabled, then at step 1006 it is determined whether the read instruction is for performing a read from an address falling within a group of addresses to which the threadlet is anticipated to write data, such as a destination buffer, as indicated by write group address indicating data. The group of addresses may in some examples be a range of contiguous addresses, but this is not required. If it is found that the read address does lie within a group of addresses anticipated to be accessed by the threadlet, then it is determined at step 1008 whether the hazard is nonetheless not possible because the read address has already been written to by the threadlet, as indicated by the write progress indicator. If the read address has already been written to by the threadlet, then reading from that location will not be out of program order, and therefore the write may be allowed to proceed. This is an example of the write progress indicator being used to filter the set of memory accesses which at first appear to present a data hazard as the read address lies in the range of anticipated accesses by the threadlet, but in practice no longer present a hazard when the threadlet has progressed past a certain point of processing.

If at step 1008 it is determined that the read address is an address to which the threadlet has not yet written data, then a read-after-write (RAW) hazard is identified. Reading from the read address at this point could cause the CPU 51 (or data processing pipeline) to read incorrect data, because it should instead be reading data produced by the threadlet (or a subsequent instruction). Hence, at step 1010 the read is prevented from accessing the data at the read address in memory.

At step 1012, it is determined whether the threadlet is a special case where the read can be translated. For example, it is determined whether the threadlet is performing a task for moving data to the read address from some other address in memory (such as memcpy). If so, then the read to the read address can be translated to a read from the other address at step 1014 and allowed to proceed at step 1016.

If not, however, then it may be required to wait for the threadlet to produce the data to be read. Hence, at step 1018 it can be determined whether the progress indicator indicates that the read address is an address to which the threadlet has written data. When this condition is satisfied, at step 1020, then the read may be allowed to proceed to read data from the read address. After the threadlet has written the data to the memory system, the most up-to-date copy of that data may be stored in a cache private to the TE 52 (e.g., L1 cache 54). To enable the processing pipeline to access this data, the read may be accompanied by a flush to flush the data from the L1 cache 54 to a lower, shared, location in memory such as the L2 cache 55 or main memory. Alternatively, a coherency protocol may be relied on to ensure that the read performed at step 1020 accesses the up-to-date version of the data. For example, the data may be returned to the CPU 51 in response to a snoop request which hits against the data in the L1 cache 54.

In the way discussed above, RAW hazards can be avoided through use of the grouped address indicating data indicating addresses anticipated to be written to by the threadlet.

FIG. 11 is a state diagram illustrating different states of hazard checking with respect to a particular TE, and the transitions between said states in response to decoding of an XSYNCN instruction, the XSYNCN instruction being an example of an extension hazard checking moderating instruction as discussed above. The use of the XSYNCN instruction allows hazard checking to be selectively enabled or disabled for particular TEs, for particular types of memory accesses, and can result in a reduced amount of hazard checking storage being required when executing regions of code (after an XSTARTN instruction) where a programmer is confident hazards will not arise.

When hazard checking is disabled in respect of a particular type of memory access, instructions for performing that type of memory access after the extension start instruction in the program order will not cause the hazard detection circuitry to perform a hazard check. The hazard detection circuitry will not, for example, compare the address to be accessed against the range of memory addresses anticipated to be accessed during the delegated task even if the data processing pipeline is in the extension hazard checking state in respect of the delegated task. This can reduce delays associated with hazard checking, and can also provide a power saving.

An example of the XSYNCN instruction has the following encoding:
XSYNCN <imm1>, <imm2>, <imm3>
   in which the immediate values have the following meanings:
imm1: enable or disable guarantee that hazard-checking is not required−#0=disable guarantee, #1=enable guarantee
imm2: specifies the types of memory accesses to which the XSYNCN instruction relates−#0=reads, #1=writes, #2=reads and writes
imm3: identifies a particular TE in examples where multiple TEs are supported and hazard checking can be enabled and disable on a per-TE basis.

It will be appreciated that this is merely an example. In some examples, immediates may not be used and parameters may be set in registers instead (which may or may not be identified by the instruction). Also, whilst specific immediate values have been used here for different meanings, it will be appreciated that these can be changed freely, and may be implemented in several different ways.

FIG. 11 illustrates the use of an XSYNCN instruction according to the above example for transitioning between different hazard checking states. In state 140, the hazard detection circuitry (e.g., the CDR unit) is configured to determine whether the hazard condition is present in respect of reads and writes to be performed by the data processing pipeline in response to instructions following the extension start instruction in program order. In states 142 and 144, the hazard detection circuitry is configured to determine the presence of the hazard condition for reads only and writes only, respectively, and therefore does not need to track certain writes/reads and/or does not need to store data to the write address storage element or the read data storage element respectively. Hence, it becomes less likely that the amount of stored state will exceed a threshold and therefore less likely that the pipeline will be stalled, which can improve performance in some cases. In state 146, hazards for neither reads nor writes are detected and therefore the amount of state required is reduced even more than in states 142 and 144.

Transitioning from state 140 to a state in which a certain amount of hazard checking is disabled can be achieved using an XSYNCN #1<imm2> instruction as illustrated in FIG. 14. The XSYNCN #1<imm2> instruction enables a guarantee that hazard checking is not required in respect of the type of memory access specified by <imm2> (for the TE specified by <imm3>, although for clarity the third field is excluded in the present example). The XSYNCN #1 instruction can also be used to transition from a state in which one type of hazard checking is disabled to a state where both types are disabled (as illustrated in the transitions from states 142 and 144 to state 146).

The guarantee that hazard checking is not required for a particular type of memory access can be reversed by using the XSYNCN #0<imm2> instruction which can apply to either one or both types of memory access as illustrated in the transitions from state 146 to 142 and 144, and from states 142 and 144 to state 140.

FIG. 12 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 730, optionally running a host operating system 720, supporting the simulator program 710. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 730), some simulated embodiments may make use of the host hardware, where suitable.

The simulator program 710 may be stored on a computer-readable storage medium (which may be a non-transitory medium), and provides a program interface (instruction execution environment) to the target code 700 (which may include applications, operating systems and a hypervisor) which is the same as the interface of the hardware architecture being modelled by the simulator program 710. Thus, the program instructions of the target code 700 described above, including the XSTARTN and XSYNCN instructions, may be executed from within the instruction execution environment using the simulator program 710, so that a host computer 730 which does not actually have the hardware features of the apparatus 50 discussed above can emulate these features.

For example, the simulator program 710 may comprise data processing pipeline program logic 1200 for simulating the data processing pipeline as illustrated in FIG. 1. The simulator program 710 may also comprise decoder program logic 1202, extension processing program logic 1204, and hazard detection program logic 1206 for simulating the decoder, extension processing circuitry 52, and hazard detection circuitry 58 respectively.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus for data processing, comprising
a data processing pipeline comprising decoder circuitry responsive to receipt of instructions of a sequence of instructions to generate control signals to control the data processing pipeline to perform data processing operations;
extension processing circuitry associated with the data processing pipeline and configured to perform a delegated task asynchronously with respect to the data processing operations performed by the data processing pipeline, in response to the decoding circuitry decoding an extension start instruction; and
hazard detection circuitry to detect data hazards associated with processing operations performed by the data processing pipeline when the data processing pipeline is in an extension hazard checking state in respect of the delegated task; wherein
when the data processing pipeline is in the extension hazard checking state in respect of the delegated task, the hazard detection circuitry is configured to determine the presence of a hazard condition in dependence on whether a given memory access, to be performed in response to execution by the data processing pipeline of a given memory access instruction following the extension start instruction in program order, is for accessing an address which falls within a group of addresses indicated by grouped address indicating data; and
the hazard detection circuitry is responsive to the presence of the hazard condition to perform a hazard resolution action.

2. The apparatus as claimed in claim 1, wherein
the decoder circuitry is responsive to an extension hazard checking start instruction to generate control signals to command the processing pipeline to enter the extension hazard checking state in respect of the delegated task.

3. The apparatus as claimed in claim 2, wherein
the extension hazard checking start instruction is the extension start instruction, such that the extension processing circuitry is configured to perform the delegated task in response to the decoding circuitry decoding the extension hazard checking start instruction.

4. The apparatus as claimed in claim 2, wherein
the extension hazard checking start instruction is arranged to specify the grouped address indicating data.

5. The apparatus as claimed in claim 4, wherein
the data processing pipeline comprises a set of registers for holding data values on which the data processing operations are performed; and
the extension hazard checking start instruction is arranged to specify the grouped address indicating data by identifying at least one register within the set of registers whose content is to be used to determine the grouped address indicating data.

6. The apparatus as claimed in claim 1, wherein
the grouped address indicating data comprises a first parameter and a second parameter, at least one of the first parameter and the second parameter providing an address indication, and the first and second parameters being used in combination to determine a start address and size of an address range.

7. The apparatus as claimed in claim 1, wherein
in the extension hazard checking state, the extension processing circuitry is configured to maintain a progress indicator indicating a subset of addresses which have been accessed by the extension processing circuitry during performance of the delegated task; and
the hazard detection circuitry is configured to detect the hazard condition in dependence on a comparison between the given address and the progress indicator.

8. The apparatus as claimed in claim 7, wherein
in the extension hazard checking state, the hazard detection circuitry is configured to access:
state defining a write group of memory addresses to which the extension processing circuitry is anticipated to write data during performance of the delegated task; and
a write progress indicator indicating a subset of write addresses within the write group to which data has been written by the extension processing circuitry during performance of the delegated task.

9. The apparatus as claimed in claim 8, wherein
the hazard detection circuitry is configured to detect a read-after-write hazard condition in response to determining that the given memory access instruction is for reading data from the given address at a position in the write group which is indicated by the write progress indicator as an address to which data has not yet been written by the extension processing circuitry.

10. The apparatus as claimed in claim 9, wherein
responsive to detection of the read-after-write hazard condition, the hazard detection circuitry is configured to perform the hazard resolution action by suppressing at least a first attempt by the processing pipeline to read data from the given address.

11. The apparatus as claimed in claim 10, wherein
responsive to detection of the read-after-write hazard condition and a determination that the delegated task is for copying data from a first region of memory to the write group, the processing pipeline is configured to translate the given address in the write group to a translated address in the first region of memory at a position to be copied by the delegated task to the given address, and issue a read request to the translated address.

12. The apparatus as claimed in claim 8, wherein
the hazard detection circuitry is configured to detect a write-after-write hazard condition in response to determining that the given memory access instruction is for writing data to the given address at a position in the write group which is indicated by the write progress indicator as an address to which data has not yet been written by the extension processing circuitry.

13. The apparatus as claimed in claim 12, wherein
responsive to detection of the write-after-write hazard condition, the hazard detection circuitry is configured to perform the hazard resolution action by causing an indication of the given address to be stored in a write address storage element associated with the extension processing circuitry, and allowing execution of the given memory access instruction to proceed in order to cause the data to be written to the given address; and
responsive to determination that a delegated write memory access is to be performed by the extension processing circuitry during performance of the delegated task to an address indicated in the write address storage element, the extension processing circuitry is configured to prevent the delegated write memory access from being performed.

14. The apparatus as claimed in claim 13, wherein
in response to determining that the write progress indicator is updated to indicate that an address associated with the write address storage element is an address to which data has been written by the extension processing circuitry during performance of the delegated task, the extension processing circuitry is configured to invalidate said write address storage element.

15. The apparatus as claimed in claim 7, wherein
in the extension hazard checking state, the hazard detection circuitry is configured to access:
state defining a read group of memory addresses from which the extension processing circuitry is anticipated to read data during performance of the delegated task; and
a read progress indicator indicating a subset of read addresses within the read group from which data has been read by the extension processing circuitry during performance of the delegated task.

16. The apparatus as claimed in claim 15, wherein
the hazard detection circuitry is configured to detect a write-after-read hazard condition in response to determining that the given memory access instruction is for writing write data to the given address at a position in the read group which is indicated by the read progress indicator as an address from which data has not yet been read by the extension processing circuitry.

17. (canceled)

18. (canceled)

19. (canceled)

20. The apparatus as claimed in claim 1, wherein
the decoder circuitry is responsive to an extension hazard checking moderating instruction to generate control signals to selectively alter operation of the hazard detection circuitry in respect of determining the presence of the hazard condition for at least one type of memory access instruction following the extension start instruction in the program order.

21. (canceled)

22. (canceled)

23. A non-transitory computer-readable medium to store computer-readable code for fabrication of the apparatus of claim 1.

24. A method for data processing, comprising
performing data processing operations in a data processing pipeline in dependence on instructions of a sequence of instructions decoded by a decoder;
performing a delegated task in extension processing circuitry associated with the data processing pipeline asynchronously with respect to the data processing operations performed by the data processing pipeline, in response to the decoding circuitry decoding an extension start instruction; and
detecting, with hazard detection circuitry, data hazards associated with processing operations performed by the data processing pipeline when the data processing pipeline is in an extension hazard checking state in respect of the delegated task;
when the data processing pipeline is in the extension hazard checking state in respect of the delegated task, employing the hazard detection circuitry to determine the presence of a hazard condition in dependence on whether a given memory access, to be performed in response to execution by the data processing pipeline of a given memory access instruction following the extension start instruction in program order, is for accessing an address which falls within a group of addresses indicated by grouped address indicating data; and
responsive to the presence of the hazard condition, performing a hazard resolution action.

25. A non-transitory computer-readable storage medium storing a computer program for controlling a host data processing apparatus to provide an instruction execution environment, the computer program comprising:
data processing pipeline program logic comprising decoder program logic responsive to receipt of instructions of a sequence of instructions to generate control signals to control the data processing pipeline program logic to perform data processing operations;
extension processing program logic associated with the data processing pipeline program logic and configured to perform a delegated task asynchronously with respect to the data processing operations performed by the data processing pipeline program logic, in response to the decoding program logic decoding an extension start instruction; and
hazard detection program logic to detect data hazards associated with processing operations performed by the data processing pipeline program logic when the data processing pipeline program logic is in an extension hazard checking state in respect of the delegated task; wherein
when the data processing pipeline program logic is in the extension hazard checking state in respect of the delegated task, the hazard detection program logic is configured to determine the presence of a hazard condition in dependence on whether a given memory access, to be performed in response to execution by the data processing pipeline program logic of a given memory access instruction following the extension start instruction in program order, is for accessing an address which falls within a group of addresses indicated by grouped address indicating data; and
the hazard detection program logic is responsive to the presence of the hazard condition to perform a hazard resolution action.
